(19) United States
(12) Patent Application Publication
(10) Pub. No.: US 2011/0286647 A1
(43) Pub. Date: Nov. 24, 2011

(54) Image Browsing and Navigating User Interface

(75) Inventors: Bo Cao, Beijing (CN); Wei Peng, Beijing (CN); Paul Tan, Beijing (CN)

(73) Assignee: Microsoft Corporation, Redmond, WA (US)

(21) Appl. No.: 12/786,210

(22) Filed: May 24, 2010

(51) Int. Cl. G06K 9/00; G06F 3/048

(52) U.S. Cl. 382/131; 715/850

(57) ABSTRACT

Techniques for image browsing, navigating and user interface operation are described herein. An image cube, having three axes representing a medical patient's body parts, imaging technology and image date, may be displayed on a visual display. Image piles of icons or thumbnail images may be positioned within the image cube, according to the three axes. By fixing the body parts axis on a specific body part, an image plane may be selected from the image cube. The selected image plane replaces the image cube in the visual display, including only image piles of the selected body part, organized according to axes indicating imaging technology and image date. An image pile may be selected from the image plane, to replace the image plane on the visual display. Image pile operations allow the user to select from the image pile a desired image(s) for display.

### BACKGROUND

Many hospitals have used a PACS (Picture Archiving and Communication System) or similar image archiving system for a number of years. As a result, the system used may include a number of patients, each associated with a number of images, perhaps taken at different times over several years. Additionally, the images taken may have been created with more than one technology (modality), such as computed tomography (CT scanning), X-ray images (XA) and magnetic resonance imaging (MRI).

Medical personnel frequently have reason to obtain one or more images stored in the system. Unfortunately, it is difficult for medical personnel to quickly learn the extent of a patient's available images, to identify the images more relevant at the present, and to obtain and view those images. Accordingly, advancements in image browsing and navigating would assist medical personal and help to ensure better patient care.

### SUMMARY

Techniques for image browsing, navigating and user interface operation are described herein. An image cube, having three axes representing a medical patient's body parts, modality (imaging technology) and image date, may be displayed on a visual display. Icons or thumbnail image piles representing patient images may be positioned within the image cube, according to appropriate coordinates along the three axes. An image plane may be selected from the image cube, typically by fixing the “body part axis” on a desired body part (e.g., the stomach). The selected image plane replaces the image cube in the visual display, including only image piles of the selected body part, organized according to axes indicating modality and image date. An image pile may be selected from the image plane, to replace the image plane on the visual display. Image pile operations allow the user to select from the image pile a desired image(s) for display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is an example of an image cube configured to support image browsing, navigating and user interface operation. Image piles within the cube are illustrated, each image pile positioned according to coordinates on the three axes indicating body part, modality and date of image.

FIG. 2 is an example of an image plane. In some instances, an image plane is selected by fixing a body part axis of the image cube of FIG. 1.

FIGS. 3A, 3B and 3C illustrate an example of a selected image pile, the selection of one or more thumbnail images from within the image pile, and display of an image associated with one of the selected thumbnail images, respectively.

FIGS. 4-7 show a second example of an image cube, having an alternative construction, and collectively show examples of axis translation and scaling, and of image plane transparency.

FIG. 8 is a block diagram illustrating an example configuration that supports image browsing, navigating and user interface operation.

FIG. 9 is a flow diagram illustrating example processes for providing image browsing, navigating and user interface operation.

FIG. 10 is a flow diagram illustrating examples of image cube operations, which support portions of a user interface displaying an image cube.

FIG. 11 is a flow diagram illustrating examples of operations applicable to an image pile or a plurality of image planes, such as the image planes forming the image cube of FIGS. 4-7.

FIG. 12 is a flow diagram illustrating examples of image plane operations, which support portions of a user interface displaying an image plane, such as FIG. 2.

FIG. 13 is a flow diagram illustrating examples of image pile operations, which support portions of a user interface displaying an image pile.

FIGS. 14-23 show examples of operations that allow manipulation of image piles and image planes, such as the image piles of FIG. 3 and the image planes forming the image cube of FIGS. 4-7.

### DETAILED DESCRIPTION

The disclosure describes techniques for providing an image browsing and navigating user interface. The image browsing and navigating user interface allows a user to successively display: an image cube; an image plane; and an image pile. Image pile operations may be used to select and view high-resolution images associated with thumbnail images within the image piles. An example illustrating some of the techniques discussed herein—not to be considered a full or comprehensive discussion—may assist the reader.

An image cube may be displayed on a visual display. The image cube may be transparent or translucent, and image piles (e.g., icons or piles of thumbnail images) may be viewable within the image cube. Such image piles represent images taken of a patient, and may be positioned within the image cube according to three axes of the image cube. Position along a first axis indicates a body part (e.g., head or lungs) which may be displayed within images. Position along a second axis indicates a modality of the image (e.g., the image's technology, such as X-ray or CT scan). Position along a third axis indicates a date of image(s). Image cube operations provide functionality including zooming in or out and rotating the image cube. Other operations, such as axis scaling and translation, allow the user to view a different subset of a patient's images. For example, the user may change a range of dates of images displayed by the image cube. Image cube operations also allow the selection of an image plane, typically by fixing or setting one axis of the image cube. For example, the body part axis may be fixed according to one specific body part to obtain an image plane associated with images of that specific part of the patient's body.

Upon selection of an image plane, possibly associated with images a specific part of the patient's body, other image planes may be cleared from the visual screen. Image plane operations allow the user to translate and scale axes of the image plane, to facilitate selection image piles having a desired image technology and image date.

Both display of the image cube and display of a single image plane provide the user with opportunities to select one or more desired image piles associated with a desired body part, modality (image technology) and/or date of image. Having selected one or more image piles, image pile operations allow the user to manipulate thumbnail images within the selected image piles, and to select one or more images for viewing.

The discussion herein includes several sections. Each section is intended to be non-limiting; more particularly, this entire description is intended to illustrate components which may be utilized in an image browsing and navigating user interface, but not components which are necessarily required. The discussion begins with a section entitled “Example Image Browsing and Navigating User Interface Architecture,” which describes one environment that may implement the techniques described herein. This section depicts and describes an image browsing and navigating user interface a high-level architecture, and suggests some detail of components which may be included in some configurations. Next, a section entitled “Alternative Image Browsing and Navigating User Interface Architecture” illustrates and describes aspects provide an alternative image cube design. A section, entitled “Example System Design” illustrates and describes an example software architecture configured to support an image browsing and navigating user interface. A section, entitled “Example Flow Diagrams” illustrates and describes techniques that may be used to support an image browsing and navigating user interface. Finally, the discussion ends with a brief conclusion.

This brief introduction, including section titles and corresponding summaries, is provided for the reader's convenience and is not intended to limit the scope of the claims, nor the proceeding sections.

### Example Image Browsing and Navigating User Interface Architecture

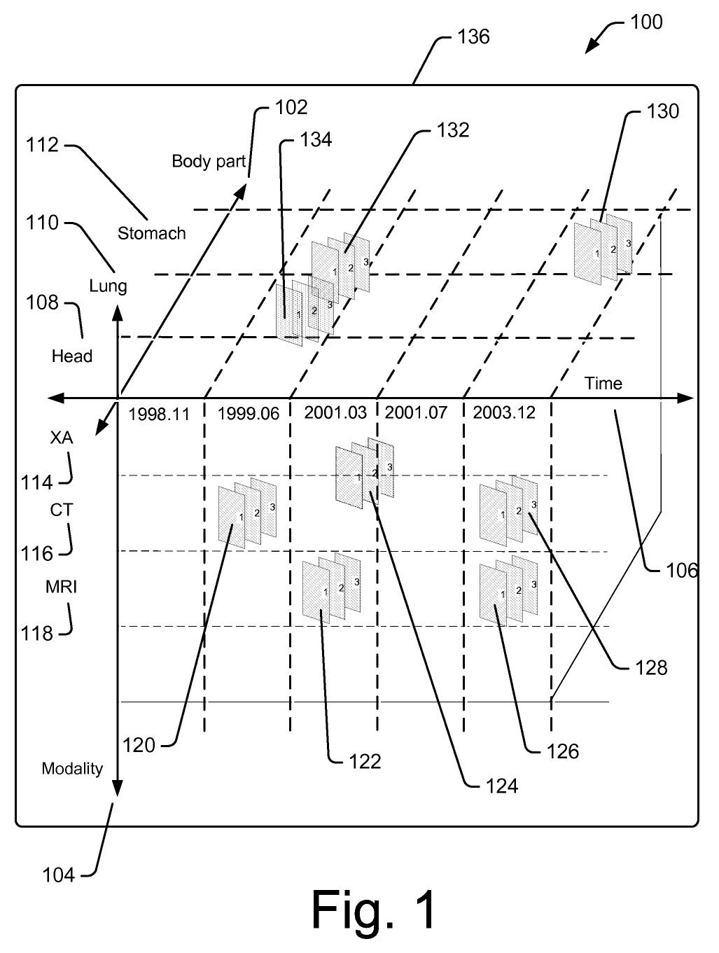

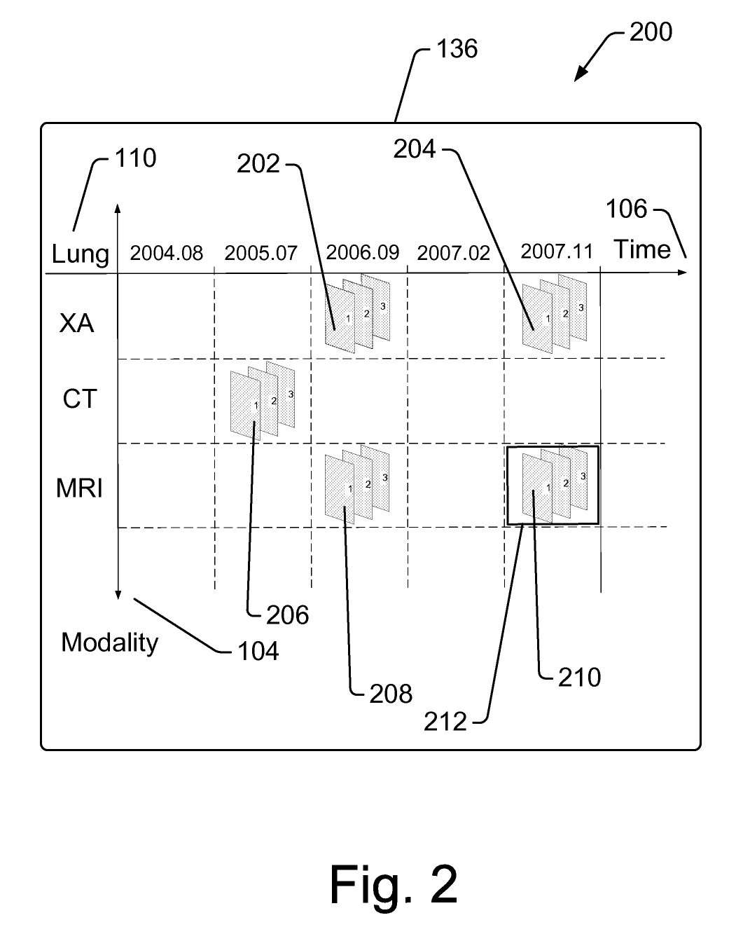

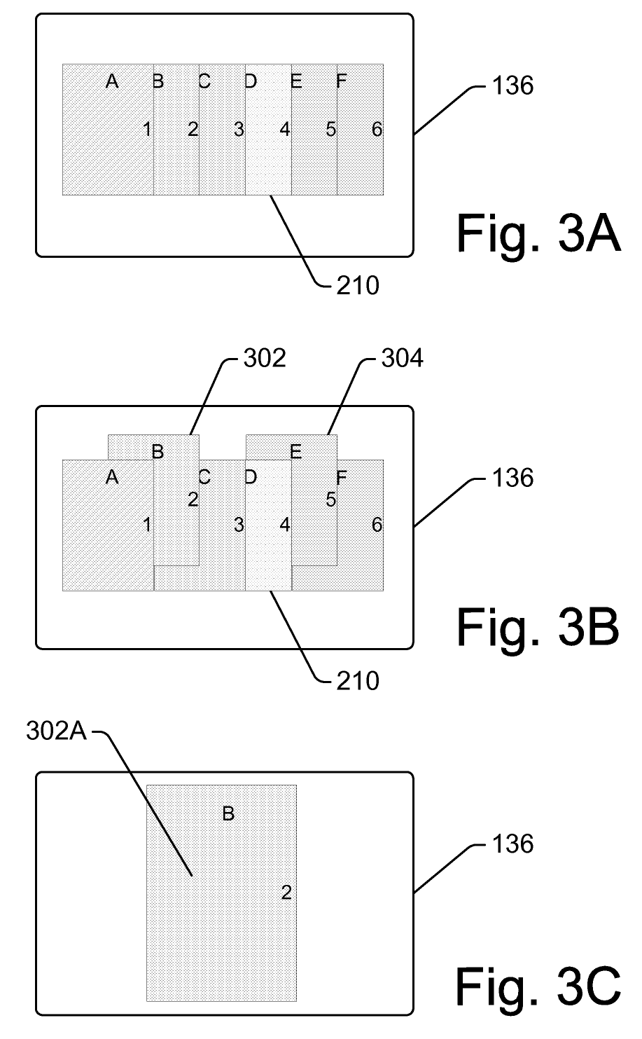

FIG. 1 is a diagram illustrating an example of an image cube 100, which may be displayed as part of a user interface to facilitate browsing and navigating of images obtained from a patient. While a single cube 100 is shown in FIG. 1, by extension two or more image cubes could be shown simultaneously. Thus, for example, the images of two family members could be manipulated and displayed. FIG. 1 is provided as a specific instance to illustrate more general concepts, and not to indicate required and/or necessary elements. The image cube 100 assists the user in selecting image planes and/or image piles of interest. Selection of image planes allows the user to proceed to a stage of the browsing and navigation seen in FIG. 2, wherein a single image plane is displayed. Selection of image piles allows the user to proceed to a stage of the browsing and navigation seen in FIG. 3, wherein a single image pile is displayed. Using the image pile, the user is able to select and view desired images.

Referring to FIG. 1, the image cube 100 is configured according to three axes, a body part axis 102, a modality axis 104 and a time or date axis 106. In the example of FIG. 1, an axis 102 is associated with body parts, including the head, lung and stomach. If desired, the axis 102 can be translated to display other body parts, such as hip, knee and foot. By selecting one of the image plane designators Head 108, Lung 110 or Stomach 112, the user is able to select image planes associated with the patient's head, lung and stomach, respectively. Reviewing the image plane associated with the image plane designator Head 108 in more detail, this plane is associated with images of the patient's head, and includes a vertical dimension associated with the modality axis 104 and a horizontal dimension associated with the time axis 106.

An axis 104 of the image cube 100 is associated with modality, i.e., the technology used to create the images. In the example of FIG. 1, three technologies (i.e., modalities) are shown. In particular, X-ray images (XA) 114, computed tomography (CT scanning) 116, and magnetic resonance imaging (MRI) 118 are shown. However, if other technologies are present, translation along the modality axis 104 can replace and/or supplement the modalities XA 114, CT 116 and MRI 118.

An axis 106 is associated with time or date, i.e., the date on which the images were created. In the example of FIG. 1, five dates are shown, ranging from late 1998 to late 2003. While the dates are shown in year and month format, they could alternatively be shown in a year, month and date format, or other format, as desired. If the patient has images in the system associated with other dates, translation or scaling along the time axis 106 could bring those images into view within the image cube 100.

The image cube 100 contains a plurality of image piles 120-134. The image piles may be stacked thumbnail images or simply an icon, depending on requirements and/or configurations of a system within which the image cube 100 is utilized. One or more of the image piles 120-134 may be selected by a user, if desired. Selection may be made by use of a mouse, a touch screen or other user interface device, as desired or suggested by the system in which the image cube 100 is displayed. Each image pile 120-134 is located within the image cube 100 according to its respective coordinates. For example, image pile 120 is located along the “body part” axis 102 in the “head” image plane 108, indicating that image pile 120 is associated with images of the patient's head. Additionally, image pile 120 is located along the “modality” axis 104 indicating that image pile 120 is associated with CT images. Additionally, image pile 120 is located along the “time” axis 106 indicating that the image pile 120 is associated with images obtained in June of 1999.

Thus, the image cube 100 includes image planes associated with body parts, wherein each image plane is organized according to a modality axis and a time axis. Translation and scaling along any of the three axes can adjust the body parts, imaging technologies and image dates displayed by the image cube 100 within the visual screen 136. The image cube 100 allows selection of an image plane (e.g., an image plane associated with the head, lung, stomach or other body part) or direct selection of image piles 120-134.

FIG. 2 is an example of an image plane 200 displayed within the visual screen 136. Thus, FIG. 2 represents a narrowing of the broader selection of images presented in FIG. 1. In particular, FIG. 2 includes only images of the patient's lung. The image plane 200 could be obtained by fixing the “body part” axis 102 of FIG. 1 at the Lung 110 designator. Because the axis 102 was fixed at Lung 110, images of other body parts are unavailable in the image plane 200, and the image plane 200 includes image piles associated only with the patient's lung. The range of the time axis 106 has been adjusted (e.g., by the user's interaction with the user interface) to extend from 2004.08 (August of 2004) to 2007.11 (November of 2007). The range of the modality axis 104 includes XA, CT and MRI. Within this range of dates and imaging technologies, there are five image piles 202-210. Thus, the refined selection of images presented in FIG. 2 represents a narrowing of the more extensive selection of images presented in FIG. 1. This refinement may be very helpful to the user desiring images of the lung. Analogously, if the user desired images of a different body part, the body part axis 102 could alternatively be fixed at a different location, thereby resulting in an image plane associated with images of the different body part.

The image plane 200 allows the user to select an image pile for further manipulation and/or examination of the images associated with the selected image pile. By use of a selection or highlighting tool at 212, the user is able to select a desired image pile, e.g., image pile 210.

FIG. 3A illustrates an example of a selected image pile displayed within the visual screen 136. In the example of FIG. 3A, image pile 210 has been selected and is displayed. Image pile 210 may include thumbnail images representing the actual images, but having much reduced resolution and/or information. Alternatively, the image pile 210 may include simple icons or generic images.

Accordingly, FIG. 3A represents a narrowing of the broader selection of images presented in FIG. 2. In particular, FIG. 3A includes only MRI images taken in November of 2007. The image pile 210 could have been obtained by the user by selecting the image pile 210 from the image plane 200 in FIG. 2. Alternatively, if the user could have manipulated the image cube 100 of FIG. 1 to result in appearance of the image pile 210, then the user could have selected the image pile 210 directly from the image cube 100.

FIG. 3B illustrates the image pile 210 within the visual screen 136. In particular, FIG. 3B illustrates that the user has selected the thumbnail images 302 and 304 from the image pile 210. FIG. 3C illustrates display of the full-resolution image 302A, which is associated with the thumbnail image 302.

FIGS. 1-3C collectively represent an example of image browsing and navigation. At FIG. 1, the image cube 100 allows the user to select the image plane 200, associated with images of a body part, such as the lung, that may interest the user. In FIG. 2, the user selected image pile 208, associated with MRI images taken of the lung in November of 2007. In FIG. 3A-C, the user reviewed the image pile 208, selected two images, and displayed the full-resolution image of one of the selected images.

### Alternative Image Browsing and Navigating User Interface Architecture

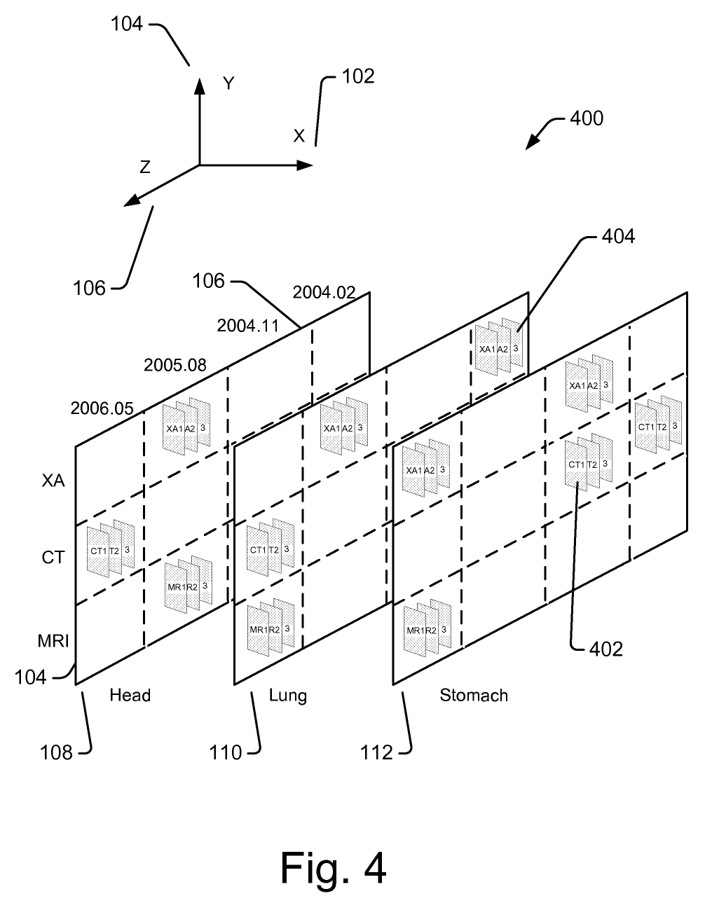

FIGS. 4-7 show a second example of an image cube, and collectively show examples of axis translation and scaling, and of image plane transparency. Referring to FIG. 4, image cube 400 is consistent with the general concepts disclosed with respect to image cube 100 of FIG. 1 and associated discussion in the text. However, the image cube 400 appears in an “exploded” configuration, wherein a plurality of image planes of the image cube are separately configured and displayed, and organized by three mutually perpendicular axes. The image cube 400 is oriented according to three mutually perpendicular axes, a body part axis 102, a modality (image technology) axis 104 and a time (date of image) axis 106. Three image planes 108-112 are shown, each located at a different position along the body part axis. Since the image planes are “exploded” the body part axis is not shown. Image plane 108 is associated with images of the head, image plane 110 is associated with images of the lung, and image plane 112 is associated with images of the stomach. Three modalities are shown along the modality axis 104, including XA (X-ray), CT and MRI. The time axis 106 shows a range of dates from 2004 to 2006. Within the image cube 400, a number of image piles are shown. In particular, an image pile 402 is associated with images of the stomach, taken using CT technology, and taken in November of 2004. Similarly, image pile 404 includes images associated with the lung using X-ray technology in February of 2004.

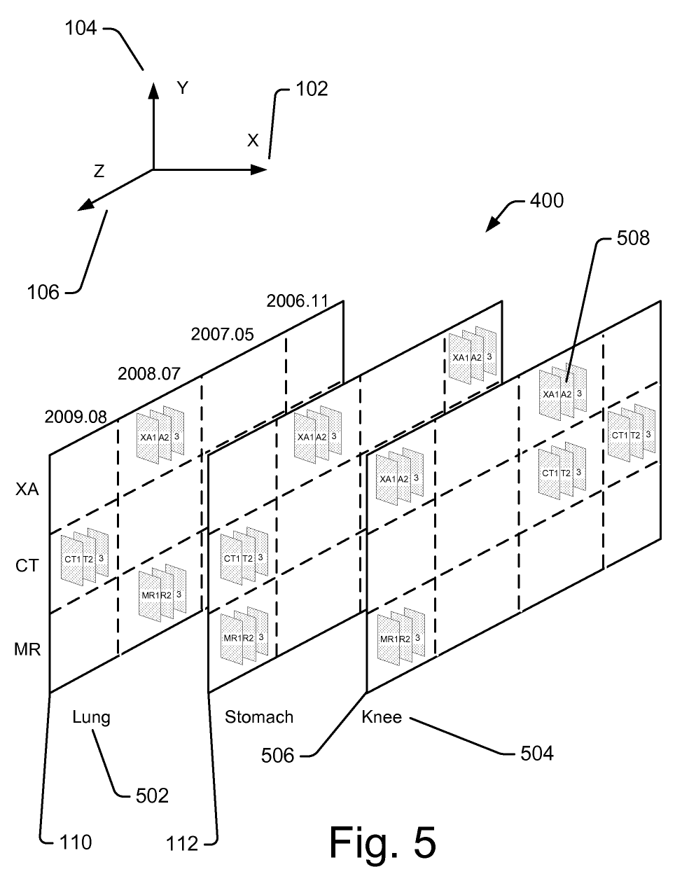

FIG. 5 shows the image cube 400 after some user-initiated image cube manipulations. In particular, the user has translated along the body part axis 102. The body part axis 102 still displays three body parts; however, the body parts displayed have changed from head, lung and stomach (FIG. 4) to lung, stomach and knee (as seen in FIG. 5). Thus, the translation along axis 102 changes the body parts displayed on the body parts axis. The translation may be initiated by the user using any desired user interface technique, such as by allowing the user to use a mouse or touch screen to drag the word Lung 502 to the left, thereby causing the designator Head (as seen in FIG. 4) to scroll out of view, and the designator Knee 504 and associated knee image plane 506 to scroll into view. Additionally, the user has translated along the time axis 106, thereby changing the dates from 2004 to 2006 (as displayed in FIG. 4) to 2006 to 2009 (as displayed in FIG. 5). Due to the translation, image piles 402 and 404 (seen in FIG. 4) are now out of view, and image pile 508 and others are currently in view.

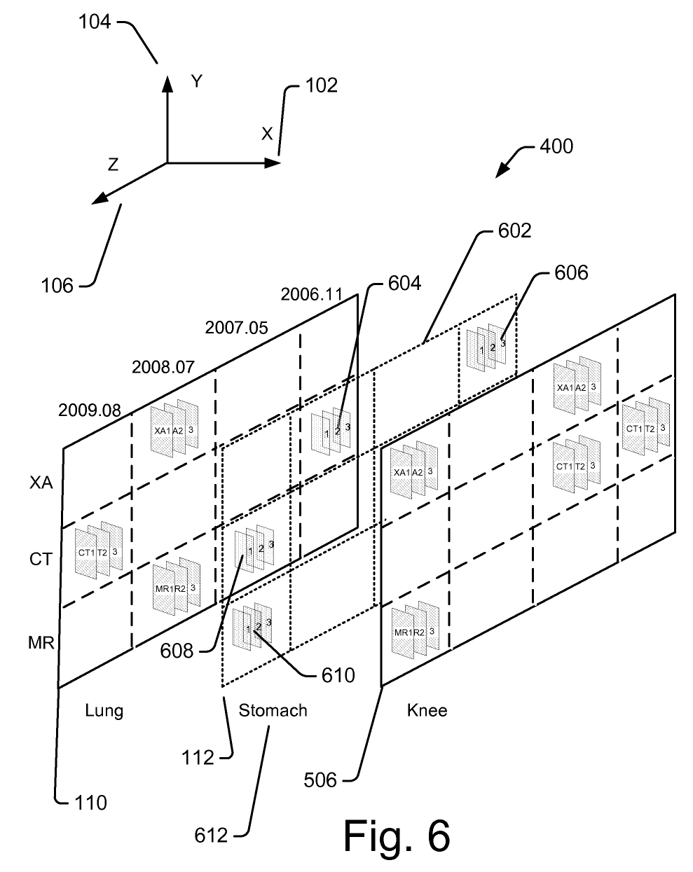

FIG. 6 shows the image cube 400 after further user-initiated image cube operations. In particular, the user has turned the stomach image plane 112 partially transparent. Thus, the framework 602 and images piles 604-610 have become partially transparent, thereby allowing the user to better see the Lung image plane 110, located partially behind the stomach image plane 112. The degree to which the Stomach image plane 112 is made transparent can be controlled and adjusted, from partial transparency to complete invisibility. Note that in the event that complete invisibility is selected by the user, the image planes Lung 110 and Knee 506 may be realigned, to better utilize the space available. For example, if image plane 112 is made completely invisible, and if excessive space between image planes 110 and 506 results, then a realignment of image planes 110, 506 may result in movement of one or both image planes and better use of the space. Any desired user interface technique may be used to provide an image plane transparency function to the user, such as by right-clicking the indicator Stomach 612 and selecting a degree by which to make the image plane 112 transparent.

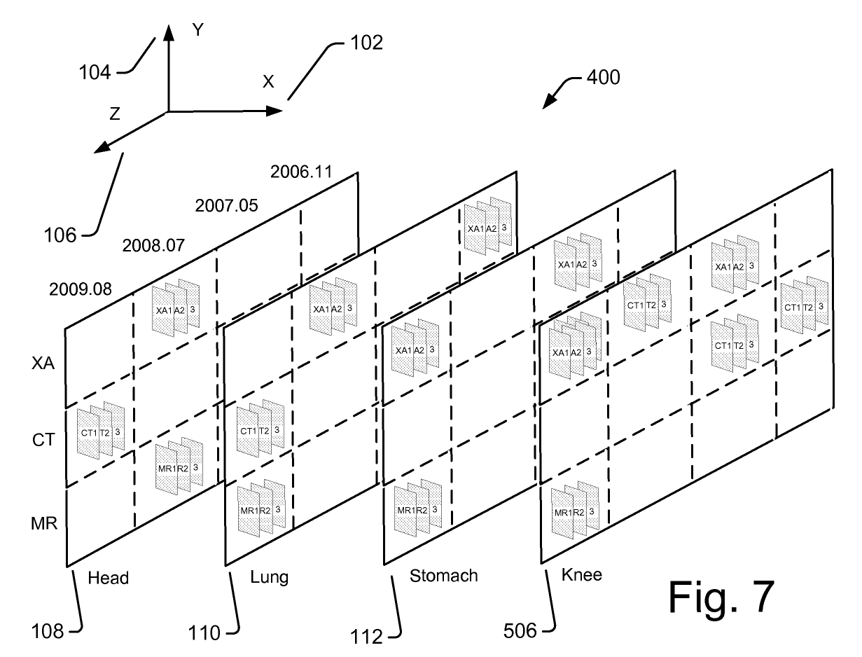

FIG. 7 shows the image cube 400 after further user-initiated image cube operations. In particular, the user has scaled the body part-axis 102, thereby adjusting a number of body part planes displayed along the body-part axis. In the example of FIG. 7, the scaling has resulted in shrinking or compression of the axis, and therefore allows the addition of a fourth body part image plane. Accordingly, image planes 108-112, and 506 are displayed. Note that scaling can be performed in both directions, i.e., axis scaling can be used to display more or fewer image planes within the image cube 400. Any desired user interface technique may be use to provide an axis scaling function to the user, such as by allowing the user to push or pull the arrowhead on the body part axis 102 toward or away from the origin of the coordinate system in the upper left of FIG. 7. Alternatively, intuitive touch motions could be used in a touch screen environment.

### Example System Design

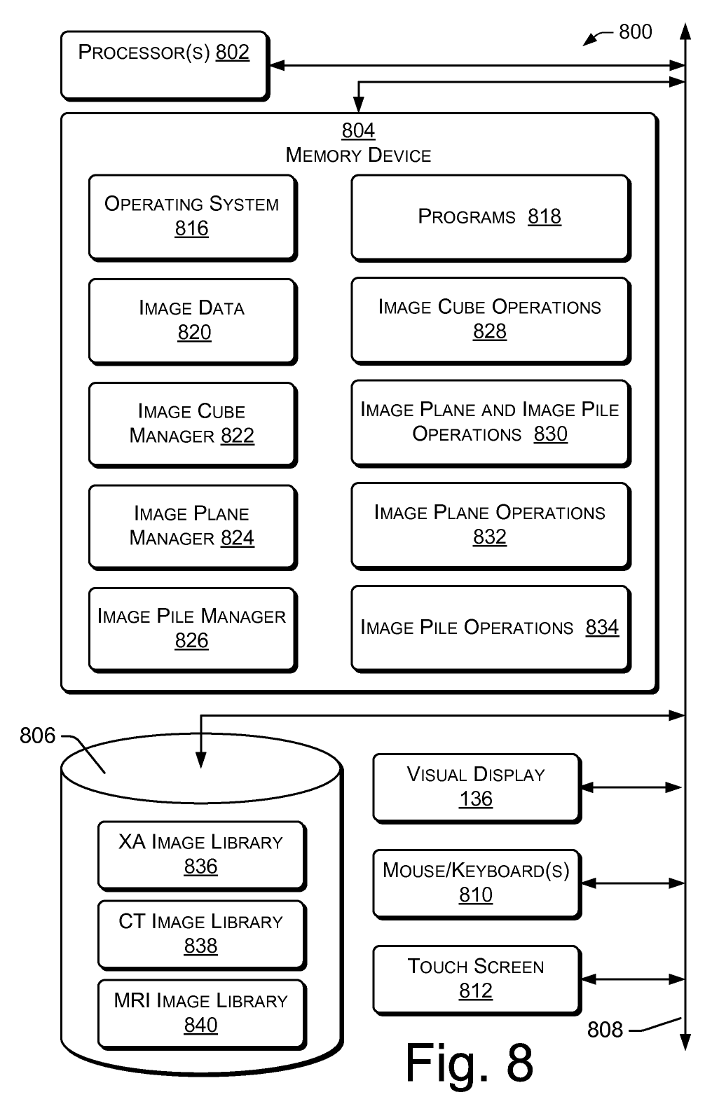

FIG. 8 is a block diagram illustrating an example system or computing device 800 configured to support image browsing, navigating and user interface operation. A processor 802 and one or more memory devices 804, 806 are in communication over a bus 808. User interface input devices, such as visual display 136, mouse and/or keyboard 810 and touch screen 812 may optionally be in communication with the processor 802. The memory device 804 may contain an operating system 816 and one or more programs 818. The programs may include image viewing applications, data base applications and others, as indicated by the configuration of the system 800.

An image database or image data structure 820 may organize data and images for one or more patients. Accordingly, the image data 820 may comprise a database, data, metadata and/or pointers to data, including data in memory device 804 and/or memory device 806. Additionally or alternatively, the image data 820 may comprise a data structure and/or object defining an image cube for display on an image display screen, the data structure or object including aspects of image planes, image piles, thumbnail images and high-resolution images.

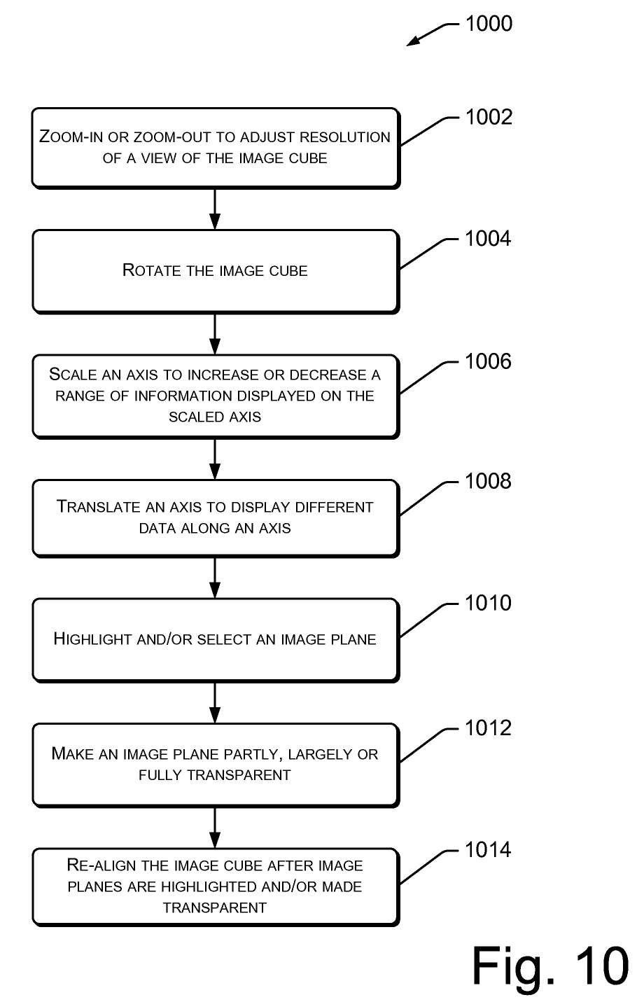

An image cube manager 822 is configured to operate a user interface, including presentation of an image cube as part of the user interface. The image cube may be the image cube 100 of FIG. 1, the image cube 400 of FIGS. 4-7, or an image cube of analogous structure and operation suggested by the elements of image cubes 100 and 400. The image cube manager may provide and support image cube operations, as well as support for graphics and user input/output. For example, the image cube manager 822 could manage input and/or output with the visual display 136, the mouse and/or keyboard 810 and the touch screen 812. Additionally, the image cube manager 822 may be configured to perform a plurality of image cube operations and/or functions. Image cube operations and/or functions may be performed within the image cube manager 822, or separately located, such as in the software (hardware and/or firmware) toolbox of image cube operations 828. The functions contained at 828 are described in more detail in FIG. 10.

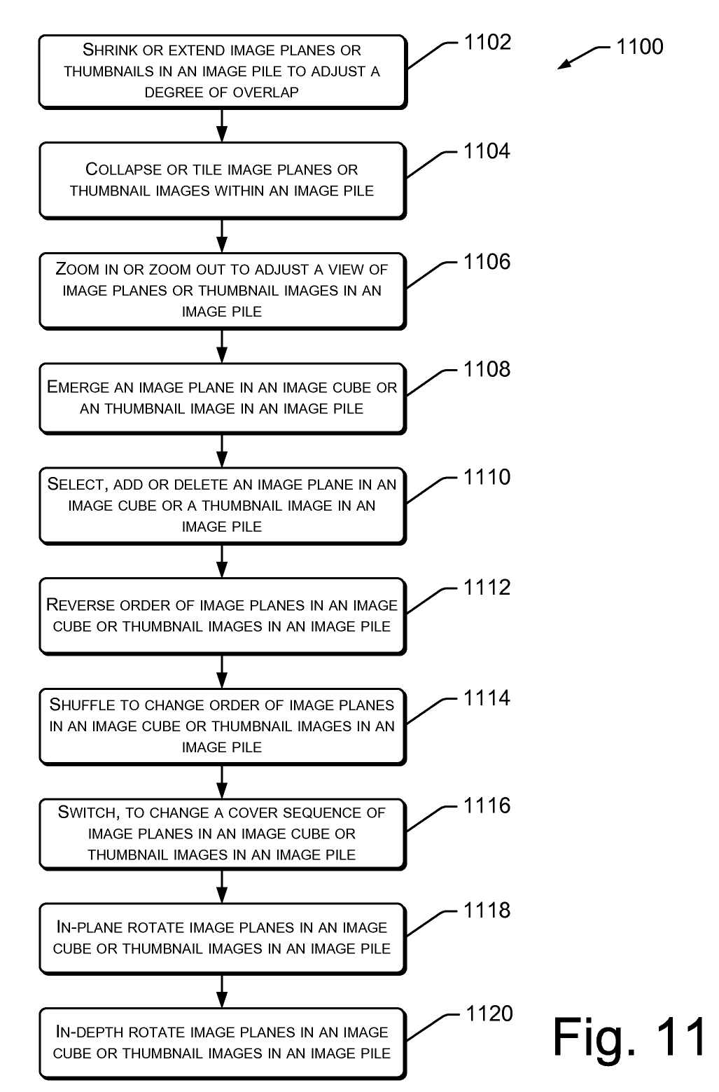

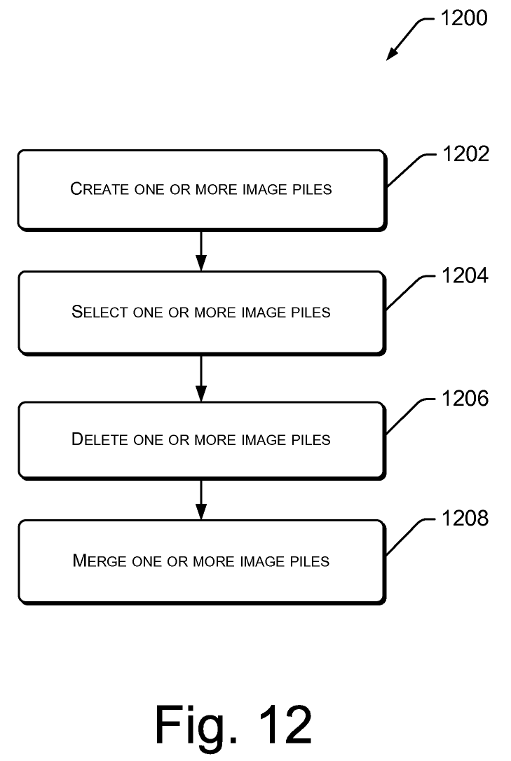

An image plane manager 824 is configured to operate a user interface, including presentation of an image plane as part of the user interface. The image plane may be image plane 200 of FIG. 2, or an image plane of analogous structure and operation suggested by the elements of the image plane 200. The image plane manager may provide and support for graphics and user input/output. For example, the image plane manager 824 could provide input and/or output to the visual display 136, the mouse and/or keyboard 810 and the touch screen 812. Additionally, the image plane manager 824 may be configured to perform a plurality of image plane operations and/or functions. Image plane operations and/or functions may be within the image plane manager 824, or separately located, such as in the software (hardware and/or firmware) toolbox image plane and image pile operations 830 and/or image plane operations 832. The functions contained at 830 are described in more detail in FIG. 11, and the functions contained at 832 are described in more detail in FIG. 12.

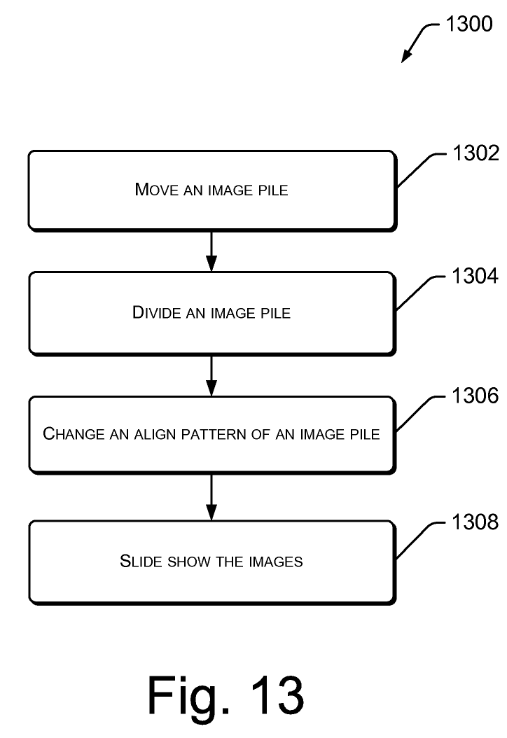

An image pile manager 826 is configured to operate a user interface, including presentation of an image pile as part of the user interface. The image pile may be image pile 210 of FIG. 3A-C, or an image pile of analogous structure and operation suggested by the elements of the image pile 210. The image pile manager may provide and support image pile operations, as well as support for graphics and user input/output. For example, the image pile manager 826 could provide input and/or output to the visual display 136, the mouse and/or keyboard 810 and the touch screen 812. Additionally, the image pile manager 826 may be configured to perform a plurality of image pile operations and/or functions. Image pile operations and/or functions may be within the image pile manager 826, or separately located, such as in the software (hardware and/or firmware) toolbox image plane and image pile operations 830 and/or image pile operations 834. The functions contained at 830 are described in more detail in FIG. 11, and the functions contained at 834 are described in more detail in FIG. 13. Collectively, the image cube manager 822, the image plane manager 824 and the image pile manager 826 are an image manager, configured to manage the images associated with one or more patients, concerning one or more body parts associated with each patient, the images taken using one or more modalities and at one or more dates.

Memory device 806 may be configured using any technology, such as solid state, magnetic and/or a large disk or disk array. Within memory device 806, the XA (X-ray) images library 836, the CT image library 838 and the MRI image library 840 are stored. Alternatively, these libraries may be configured as a single library. The images associated with one or more patients in libraries 836-840 may be stored, retrieved and organized using the image database 820 and associated data structures.

### Example Flow Diagrams

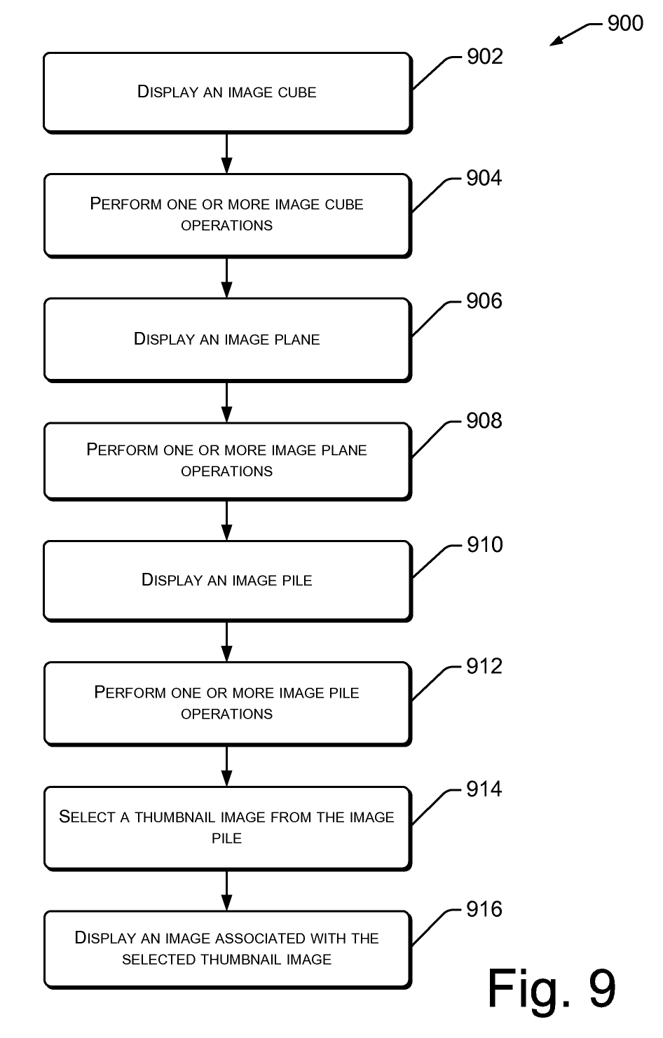

FIG. 9 is a flow diagram illustrating an example process 900 for providing image browsing, navigating and user interface operation. In one example, the process 900 describes the operation of the system or computing device 800 of FIG. 8. Accordingly, the example process of FIG. 9 can be understood in part by reference the configuration of FIGS. 1-8. However, FIG. 9 contains general applicability, and is not limited by other drawing figures and/or prior discussion. Each process described herein is illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

At operation 902, an image cube is displayed for observation and interaction with user, as part of a user interface. The image cube may be displayed on a visual display, video display or monitor. Two examples of the displayed image cube include the image cubes 100, 400 of FIG. 1 or 4-7. Display of the image cube provides a user with information on what images are available for a particular patient. However, the user may want to obtain information about the patient's images that is not currently displayed by the image cube. Accordingly, the user may want to perform one or more image cube operations.

At operation 904, the user optionally performs one or more image cube operations. For example, the user may optionally operate one or more user interface tools, such as a mouse or touch screen, to invoke or activate a function or procedure to enhance the display or operation of the user interface. Examples of image cube operations that may optionally be performed are discussed in FIG. 10.

At operation 906, an image plane is displayed for observation and interaction with user, as part of a user interface. An example of an image plane is image plane 200, in FIG. 2. Display of the image plane provides a user with information on what image piles are available for a particular patient within the image plane. The image plane may be associated with a body part or region of the patient's body. However, the user may want to obtain information about the patient's images that is not currently displayed by the image plane. Accordingly, the user may want to perform one or more image plane operations.

At operation 908, the user optionally performs one or more image plane operations. For example, the user may optionally operate one or more user interface tools, such as a mouse or touch screen, to invoke or activate a function or procedure to enhance the display or operation of the user interface. Examples of image plane operations that may optionally be performed are discussed in FIGS. 11 and 12. The image plane operations provide the user with information about the nature of the image plane and the image piles available within the image plane. Accordingly, the image plane operations assist the user to make a desirable choice of an image pile(s) from within the image plane.

At operation 910, an image pile is displayed for observation and interaction with user, as part of a user interface. An example of an image pile is image pile 210, seen in FIG. 3A. Display of the image pile provides a user with information on what images are available for a particular patient, associated with a part or region of the patient's body, associated with a particular imaging modality, and associated with a particular date of image creation. However, the user may want to determine which image(s), from among images associated with the image pile, are of particular interest. Accordingly, the user may want to perform one or more image pile operations.

At operation 912, the user optionally performs one or more image pile operations. For example, the user may optionally operate one or more user interface tools, such as a mouse or touch screen, to invoke or activate a function or procedure to enhance the display or operation of the user interface. Examples of image pile operations that may optionally be performed are discussed in FIGS. 11 and 13. The image pile operations provide the user with information about the nature of the image pile and the images represented by the image pile. Accordingly, the image pile operations assist the user to make a desirable choice of a thumbnail image from the image pile.

At operation 914, a thumbnail image is selected from the image pile. The selected thumbnail image may be a low-resolution image representing an image that the user wants to see. At operation 916, an image, associated with the selected thumbnail image, is displayed.

FIG. 10 is a flow diagram illustrating examples 1000 of image cube operations, which support portions of a user interface displaying an image cube. Accordingly, FIG. 10 describes one possible implementation to the image cube operation block 904 of FIG. 9. The operations 1000 are intended to be of a generalized nature, applicable to a variety of image cubes consistent with the discussion herein. For example, the operations 1000 may support either the image cube 100 of FIG. 1, or the image cube 400 of FIG. 4, or both. Additionally, some of the operations 1000, such as scaling 1006 and translating 1008 can be performed on an image plane, such image plane 200 of FIG. 2. In any particular implementation, some, all or none of the operations 1000 may be implemented. Moreover, the operations do not have to be performed in any particular order and one or more of the operations do not have to be executed and/or implemented by a system. However, the image cube operations 1000 provide functionality that may facilitate a user's image browsing and navigating experience when an image cube is displayed on the visual screen. Such functionality assists the user to either: (1) adjust the image cube to determine which image planes and/or image piles are available; and/or (2) select an image plane for further browsing and navigation; and/or (3) to select image piles directly, without selection of an image plane. For example, some or all of the image cube operations 1000 may assist the user to determine what image planes are available, to remove or make transparent undesired image planes, and to select desired image planes or desired image piles.

At operation 1002, a zoom function (e.g., zoom-in and zoom-out) allows the user to zoom-in or zoom-out to adjust resolution of the user's view of the image cube within the visual screen. Accordingly, the user can use the zoom function to more completely, or less completely, fill all or part of the visual screen 136, respectively, with all or part of the image cube 100. Moreover, the zoom-in function can be used to “over-fill” the visual screen, i.e., the zoom-in function can make the image cube 100, 400 is so large that only a portion of the image cube is visible. This may provide a user with detail and/or resolution required to see some portion of the image cube 100, 400 and its contents (e.g., image piles 120-132 of FIG. 1). The zoom-in and zoom-out functions may be controlled by a mouse, keyboard, touch-screen or other user interface device, as indicated by a particular installation.

At operation 1004, a rotation function turns or rotates the image cube 100 about any desired axis or line (wherein the line is not necessarily parallel to any axis). Accordingly, the user is able to orient the image cube 100, 400 to see any desired region of the cube. The rotation function may be controlled by a mouse, keyboard, touch-screen or other user interface device, as indicated by a particular installation. For example, circling motions with a mouse or finger on a touch-screen may control and/or assist in the rotate function.

At operation 1006, an axis-scaling function shrinks or extends any of the three axes. In one example of scaling an axis, the user may desire to see image piles over a greater range of dates. Accordingly, the axis-scaling function may “extend” the time axis 106 to thereby fit additional dates along the time axis of the image cube 100. While three different dates may have been displayed before scaling, four different dates may be displayed after scaling. This may allow, for example, the user to check to see if image pile(s) exist over a wider range of dates. Similarly, the axis-scaling function may “shrink” the time axis 106 to decrease the range displayed, and to thereby remove one or more dates from the time axis of the image cube. And further, axis-scaling may also be applied to the body part axis and the modality axis, to control a number of body parts and a number of technologies displayed by those axes. For example, the image cube 400 of FIG. 6 was scaled to include an additional body part image plane, as seen in FIG. 7. The axis-scaling functions—shrink and extend—may be controlled by operation of a mouse, keyboard touch screen or other user interface device, as indicated by a particular installation. For example, to shrink an axis, the user may click the mouse while moving from the arrowhead to middle of an axis. Alternatively, to extend an axis, the user may click the mouse while moving from the middle of the axis toward the arrowhead. Similar motions may control scaling on a touch screen.

At operation 1008, an axis translation function changes what is displayed within the range of the axis. For example, before translation, three body parts may be displayed on the body part axis 102. After translation, a different three body parts may be displayed. For example, before translation, FIG. 4 shows image planes associated with “head,” “lung” and “stomach” image planes. After translating one position, FIG. 5 shows image planes associated with “lung,” “stomach” and “knee.” Thus, translation would cause the “head” image plane to “scroll out of view,” and the “knee” image plane to “scroll into view.” Similarly, translation can be performed by more than one step. For example, an image cube displaying image planes associated with “head, stomach, lung” could be transformed to include image planes associated with “hip, knee, foot.” And further, translation could be performed in either direction, and on any axis. For example, the time axis could be translated from an initial display of image planes between 2002 and 2004, to a subsequent display of image planes between 2004 and 2006. The translation function may be operated by the user by any desired user interface tool. For example, the user may use a mouse or touch-screen to click and/or drag a body part (e.g., “lung 110”) or a date (e.g., 1999.06) to translate the respective axis (axis 102 or axis 106).

Thus, translation is distinguishable from axis-scaling. If the body parts axis is translated, it may display three body parts before and after translation, but the parts will not be exactly the same. If the body parts axis is scaled, the range displayed by the axis will increase or decrease, changing the number of body parts image planes may be displayed. Translation and scaling could be unified if desired, to result in a function having characteristics of both scaling and translation.

At operation 1010, a highlighting and/or selection function allows a user to highlight or select important image planes. Highlighting may be precede selection, as the user decides which image plane is most desirable. Highlighting the image plane may be indicated by making the name of the image plane—e.g. “Lung 502” of FIG. 5—bold. The selection of an image plane may translate the user interface from display of an image cube (e.g., FIG. 1 or 4) to display of the selected image plane (e.g., FIG. 2). The image plane may be highlighted or selected by use of a mouse or touch-screen. In one example, the image planes that may be highlighted or selected by action on the name of the image plane, such as “Lung 502” of FIG. 5. Thus, an image plane could be highlighted or selected by clicking or right-clicking on the body part indicator (e.g., the words “Lung 502,” “Knee 504,” of FIG. 5).

At operation 1012, a transparency function allows the user to see through image planes that appear to be of less interest. In particular, the image piles can be made somewhat transparent, substantially transparent, or even fully transparent (i.e., invisible). In the example of FIG. 6, the image plane 112 has been made somewhat transparent to allow a better view of image plane 110. The transparency includes the frame 602 and the image piles 604-610. Image planes may be made transparent by operation of any user interface button, control or operation indicated or suggested by the application. For example, an individual image plane 112 of FIG. 6 may have been made transparent by right-clicking the image plane name (Stomach 612) and selecting a degree of transparency. Similarly, any part of the image cube may be made transparent. For example, image pile 134 of FIG. 1 may have been made transparent to result in the appearance of, or to result in a better view of, image pile 132. Image pile 134 may have been made transparent by the right-click of a mouse, and appropriate selection of a transparency option.

At operation 1014, a realign function “realigns” and/or moves selected and/or highlighted planes, and removes planes that are fully or partially transparent and/or not selected. If an image plane is made partially or entirely transparent, this indicates that the user may not be interested in this image plane. If an image plane is highlighted, this indicates that the user may be interested in this image plane. The user can fully remove uninteresting image planes, and reposition interesting image planes, by operation of the realign function. Essentially, the transparent image plane(s) disappears, and the highlighted image plane(s) moves and/or expands in size to occupy space previously occupied by the transparent image plane(s). As an example of the realign function, if the “Stomach” image plane 112 (FIG. 6) is made transparent, then operation of the realign function may move the “Lung” and “Knee” image planes 110, 506 to better use available space.

FIG. 11 is a flow diagram illustrating examples of image plane and image pile operations. Thus, the operations of FIG. 11 support portions of a user interface displaying image planes or an image pile (e.g., images planes 108-112 of FIG. 4) or an image pile (e.g., image pile 210 of FIG. 3A). Accordingly, FIG. 11 describes one possible implementation to the image cube operation block 908 and/or image pile operation block 912 of FIG. 9. The operations 1100 are intended to be of a generalized nature, applicable to image planes and/or image piles consistent with the discussion herein. In any particular implementation, some, all or none of the operations 1100 may be implemented. Moreover, the operations do not have to be performed in any particular order, and one or more of the operations do not have to be executed and/or implemented by a system. However, the image plane and image pile operations 1100 provide functionality that may facilitate a user's image browsing and navigating experience when image planes or thumbnail images of an image pile are displayed on the visual screen. Such functionality assists the user to either: (1) select a desired image plane for further browsing and navigation; or (2) select a thumbnail image from an image pile for viewing of an associated enlarged or high-resolution image.

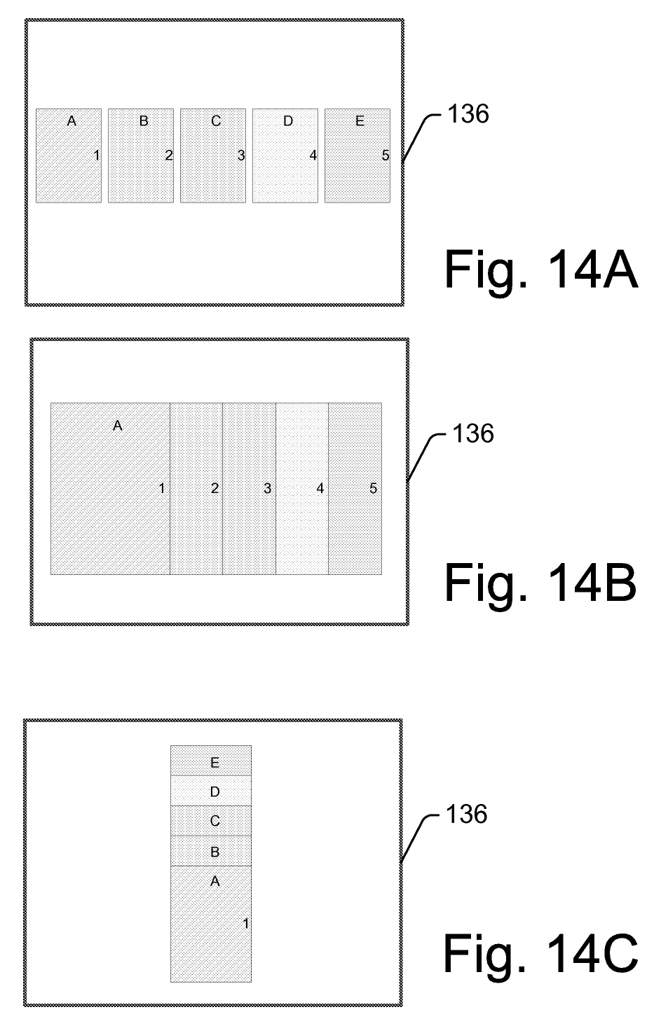

FIG. 11 illustrates aspects of image plane and image pile tiling and overlapping. Aspects of image tiling and overlapping can be understood from the example illustrated by FIG. 14A-C. At FIG. 14A, five thumbnail images are arrayed or displayed in a tiled configuration. The tiled configuration advantageously does not overlap any portion of any image. In FIG. 14B, the five thumbnail images are arrayed or displayed in an overlapping configuration. The overlapping configuration advantageously displays the first tile A1 in a larger size, perhaps having greater resolution. A drawback is that tiles 2 through 5 are only partially displayed, i.e., they are partially overlapped by other images. In FIG. 14C, the tiles are displayed in a vertically overlapped configuration. Note that while FIGS. 14A-C illustrate five thumbnail images of an image pile, a different number of thumbnail images could have been utilized. Additionally, while thumbnail images forming an image pile were illustrated in FIGS. 14A-C, the same concepts apply to image planes forming an image cube. For example, the image planes 108-112 of FIG. 4 are shown in an overlapped configuration, but could alternatively be displayed in a tiled configuration.

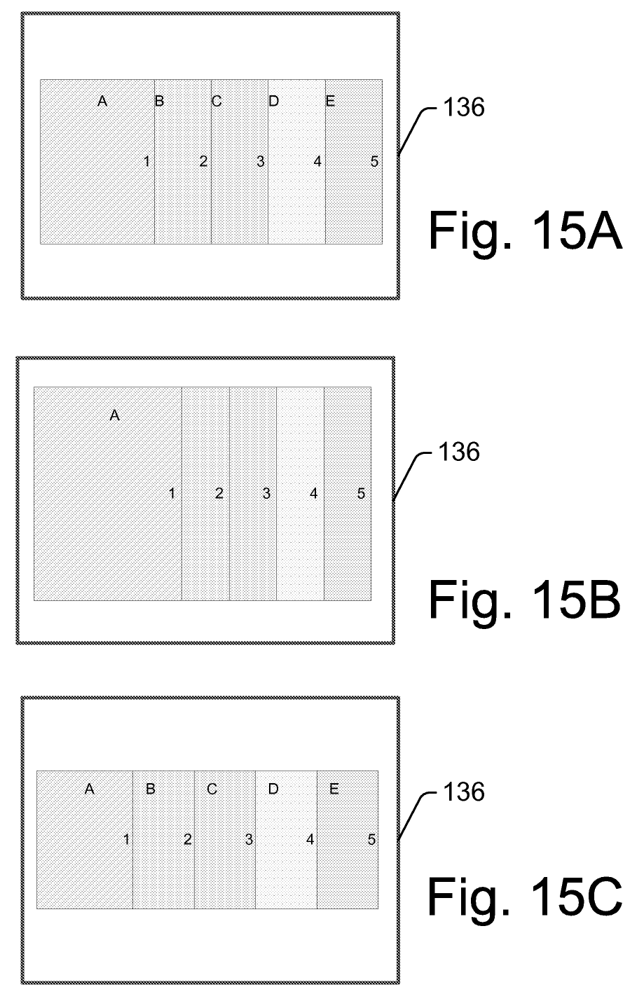

At operation 1102, a shrink or extend scaling function may be used to adjust a degree to which thumbnail images of an image pile, or image planes of an image cube (e.g., image planes 108-112 of FIG. 4) overlap each other. For example, the image pile of FIG. 15A exhibits a degree of overlap. This overlap can be increased or accentuated by a shrink function, as seen in FIG. 15B. The shrink function may increase a size and resolution of the top image (image A), but decrease a degree to which other images are displayed, due to the increase in overlap. Conversely, if an extend function is applied to the image pile of FIG. 15A, the top image is less prominently displayed, but a larger percentage of each underlying image is displayed. Thus, the pile of FIG. 15B is more “shrunk,” while the pile of FIG. 15C is more “extended.”

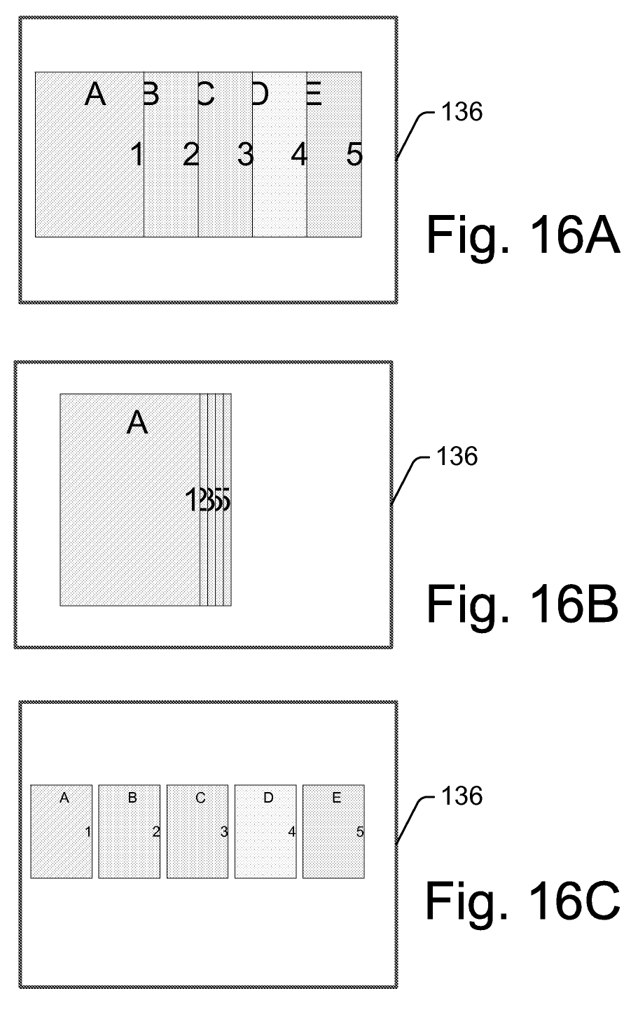

At operation 1104, a collapse or tile function is an extension of the shrink and extend function. At FIG. 16A, an overlapped pile of thumbnail images is seen. Similarly, the image planes 108-112 of image cube 400 of FIG. 4 are overlapped. The overlapping pile of thumbnail images of FIG. 16A can be collapsed, as seen in FIG. 16B, to accentuate the overlap of the thumbnail images. Alternatively, the overlapping pile of thumbnail images could be tiled, as seen in FIG. 16C, to completely eliminate the overlap of the images. Similar results could be obtained using the image planes of image cube 400.

At operation 1106, a zoom in and zoom out function allows the user to adjust a size and a center of a field of view as desired, and to increase or decrease the size of the field of view and the resolution of the field of view. For example, a user could view a larger area (e.g., more thumbnail images) at lower resolution, or a smaller area (e.g., part of a single thumbnail image) at higher resolution.

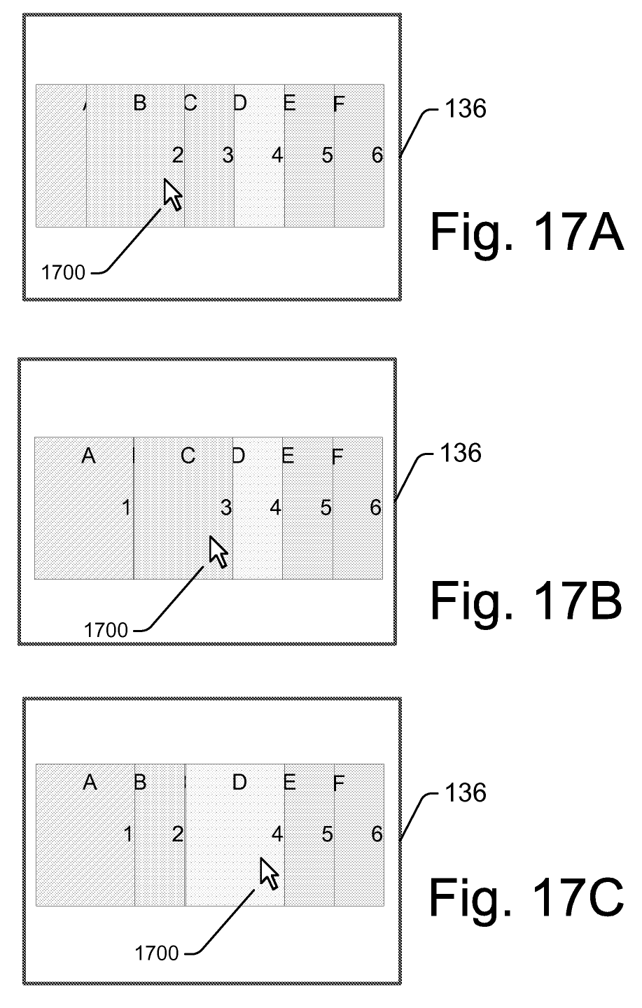

At operation 1108, an emerge function allows the user to conveniently view a thumbnail image of an image pile, or image plane of an image cube, that is partially obscured by overlapping thumbnail images or overlapping image planes, respectively. For example, an image plane or thumbnail image may be brought to the front or top layer by an operation of a user interface, and then returned to its original location. By bringing the image plane or thumbnail image to the front or top, it is fully visible to the user. Referring to FIGS. 17A-C in sequence, the cursor 1700 is moved over image B, then image C, then image D. When the cursor is over each image, that image is moved to the front or top plane, i.e., the underlying image is not overlapped by other images, thereby allowing the user to view the image without overlap by adjacent images. When the cursor moves off the emerged image, it returns to its original location, overlapped by adjacent images.

At operation 1110, a select function allows a user to select an image plane or a thumbnail image, so that additional operations may be performed, or so that an associated image (e.g., a higher resolution image) may be viewed. Alternatively, a delete function allows the user to delete the selected image plane or thumbnail image. Referring to FIGS. 3A and B, thumbnail images 302, 304, not selected in FIG. 3A, are selected in FIG. 3B. The selected images can be further processed, examined and/or deleted.

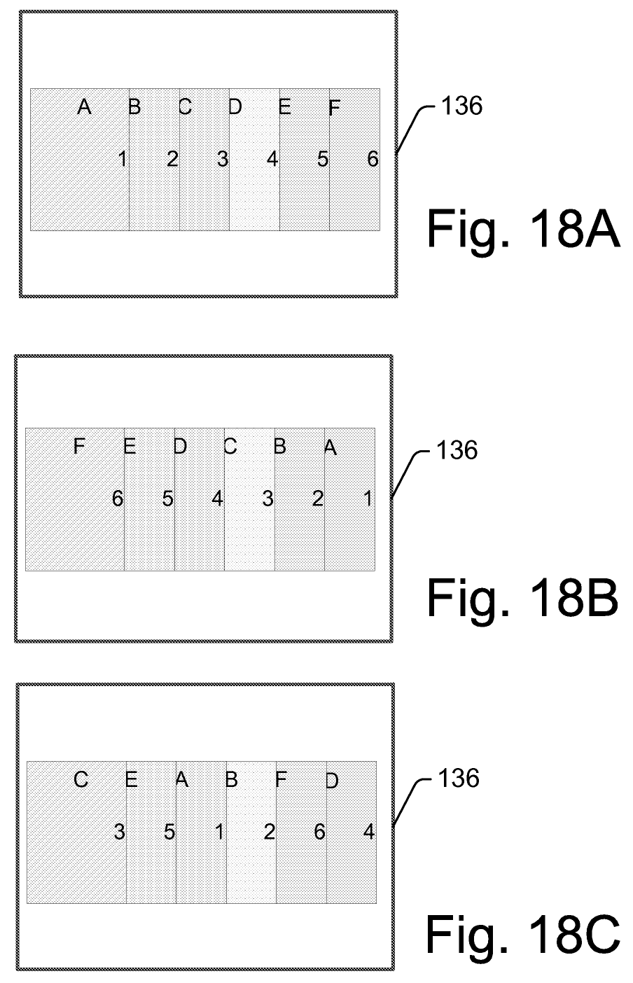

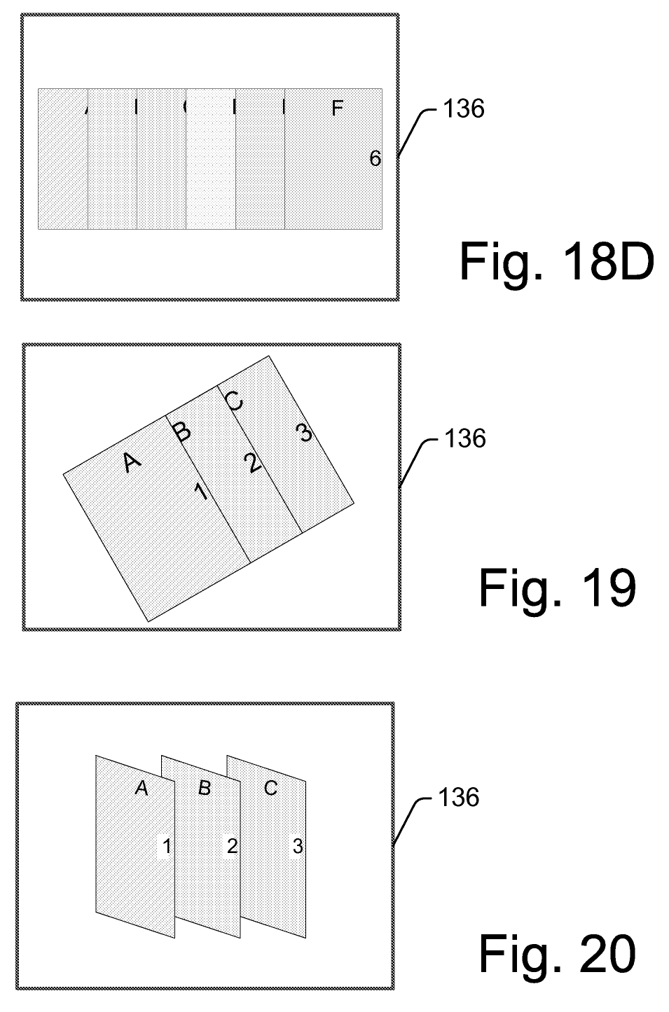

At operation 1112, a reverse order function allows a user to reverse an order of image planes or thumbnail images in an image pile. Referring to FIGS. 18A and B, execution of the reverse function reverses the order of the thumbnail images. The reverse function may help the user to obtain a better view of desired image piles or thumbnail images.

At operation 1114, a shuffle command allows the user to change the order of thumbnail images in an image pile, or change the order of image planes in an image cube (e.g. image cube 400 of FIG. 4). Example results of a shuffle command, applied to an image pile, can be seen by comparison of FIGS. 18A and 18C.

At operation 1116, a switch function allows the user to change a cover sequence of an image pile of thumbnail images or a plurality of image planes in an image cube (e.g., cube 400 of FIG. 4). Thus, while an order of the thumbnail images or image planes is not changed by execution of the switch function, an order of overlap is reversed. For example, in FIG. 18A, the first image overlaps the second image, which overlaps the third image, and so on. In contrast, after execution of the switch function the cover is reversed, as seen in FIG. 18D. After execution of the switch function, the last image overlaps the second to last image, which overlaps the third to last image, and so on. In each case, the first image (image 1) is on the left, and the last image (image 6) is on the right.

At operation 1118, an in-plane rotation may be performed, either to the image planes of an image cube (e.g., image planes 108-112 of image cube 400 of FIG. 4) or to the thumbnail images of an image pile. Referring to FIG. 19, an example of in-plane rotation, as applied to thumbnail images of an image pile, is seen. By executing an in-plane rotation, the thumbnail images rotate in the same plane at the visual screen 136, and after rotation may appear as seen in FIG. 19.

At operation 1120, an in-depth rotation may be performed, either to the image planes of an image cube (e.g., image planes 108-112 of image cube 400 of FIG. 4) or to the thumbnail images of an image pile. Referring to FIG. 20, an example of in-depth rotation, as applied to thumbnail images of an image pile, is seen. By executing an in-depth rotation of the thumbnail images of an image pile, the thumbnail images each rotate about a vertical line bisecting each thumbnail image vertically, the vertical line located in the same plane at the visual screen 136. After the in-depth rotation, the thumbnail images of the image pile appear as seen in FIG. 20. Additionally, in-depth rotation can be performed in both directions. For example, an image plane selected from among the image planes 108-112 of FIG. 4 can be in-depth rotated into the plan view (orthographic view) of the image plane 200 of FIG. 2.

FIG. 12 is a flow diagram illustrating examples of image plane operations 1200, which support portions of a user interface displaying an image plane (e.g., image plane 200 of FIG. 2). Accordingly, FIG. 12 describes aspects of a possible implementation of block 908 of FIG. 9. The operations 1200 are intended to be of a generalized nature, applicable to a variety of image plane constructions consistent with the discussion herein. For example, the operations 1200 may support operation of either the image plane 200 of FIG. 2, or an image plane of different construction. In any particular implementation, some, all of none of the operations 1200 may be implemented. Moreover, the operations do not have to be performed in any particular order, and one or more of the operations do not have to be executed and/or implemented by a system. However, the image plane operations 1200 provide functionality that may facilitate a user's image browsing and navigating experience when an image plane (e.g., image plane 200 of FIG. 2) is displayed on the visual screen. Such functionality assists the user to manage image piles.

At operation 1202, one or more image piles is created in an image plane. In the example of FIG. 2, a new image pile may be dragged and dropped into a location indicated by the modality of the images in the new image pile, and indicated by a date at which the images were created.

At operation 1204, one or more image piles may be selected. Referring to the example of FIG. 2, the image pile 210 may be selected, such as by mouse-click or touch screen. The selection is indicated by the highlighting box 212 drawn around image pile 210.

At operation 1206, one or more image piles may be deleted. In the example of FIG. 2, the selected image pile 210 can be deleted by the user by operation of the user interface. For example, by selecting the image pile and right-clicking it, a delete option could be selected.

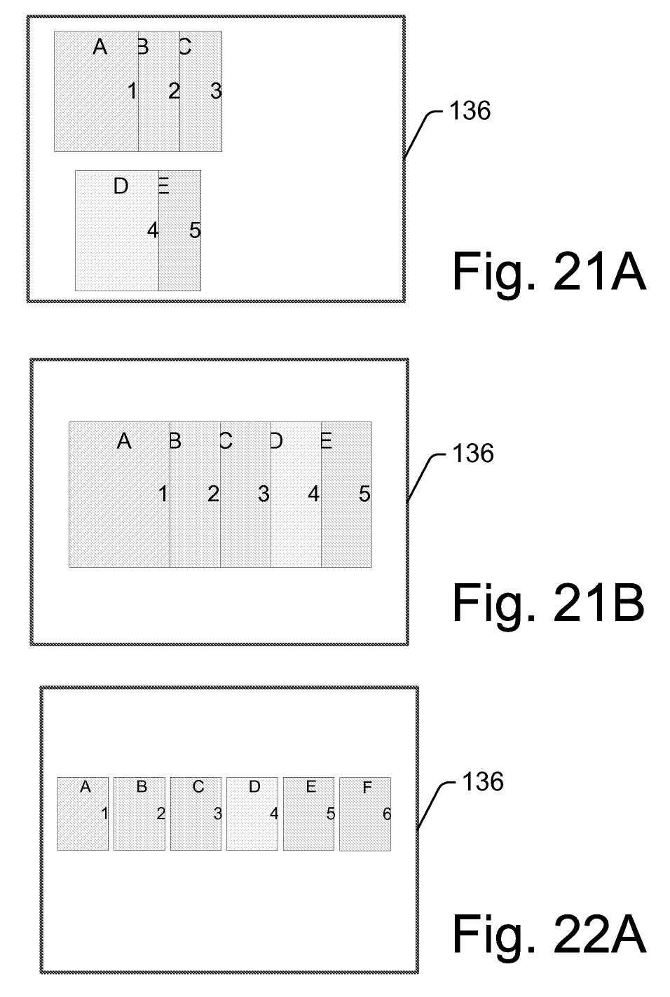

At operation 1208, two or more image piles may be merged. At FIG. 21A, two image piles are present. They can be merged into a single image pile, as seen in FIG. 21B. To facilitate merging manipulations, the user interface may tools to assist the user. For example, when two thumbnail images and/or image piles are close enough, they may be attracted toward each other, as if by “magnetism,” allowing the two piles to join into a single pile. The merged image pile may be formed according to “settings.” For example, the merged image pile may assume the size, overlapped portion, zoom factor, sequence, in-depth rotation angle, etc., of the “primary” thumbnail image and/or image pile. Determination of the “primary” image pile can be based on user selection or convention. For example, the image pile to which another image pile is moved and dropped on is “the primary image pile”.

FIG. 13 is a flow diagram illustrating examples of image pile operations 1300, which support portions of a user interface displaying an image pile. Accordingly, FIG. 13 describes one possible implementation to the image cube operation block 912 of FIG. 9. The operations 1300 are intended to be of a generalized nature, applicable to a variety of image piles or thumbnail images consistent with the discussion herein. For example, the operations 1300 may support the thumbnail images and image piles of FIG. 3A-C, or image piles of different construction. In any particular implementation, some, all or none of the operations 1300 may be implemented. Moreover, the operations do not have to be performed in any particular order, and one or more of the operations do not have to be executed and/or implemented by a system. However, the image pile operations 1300 provide functionality that may facilitate a user's image browsing and navigating experience when an image pile is displayed on the visual screen. Such functionality assists the user to determine what images are available and to select desired images.

At operation 1302, an image pile may be moved. The move can be made in a desired manner. For example, the entire image pile may be moved. For example, the image pile 210 of FIG. 2 can be moved from one position to another, such as to correctly position the image pile according to date. Alternatively, by moving one thumbnail image of an image pile, other thumbnail images may move, one-by-one in an automated fashion, perhaps stalling shortly in the moving process to allow the user to view each thumbnail image.

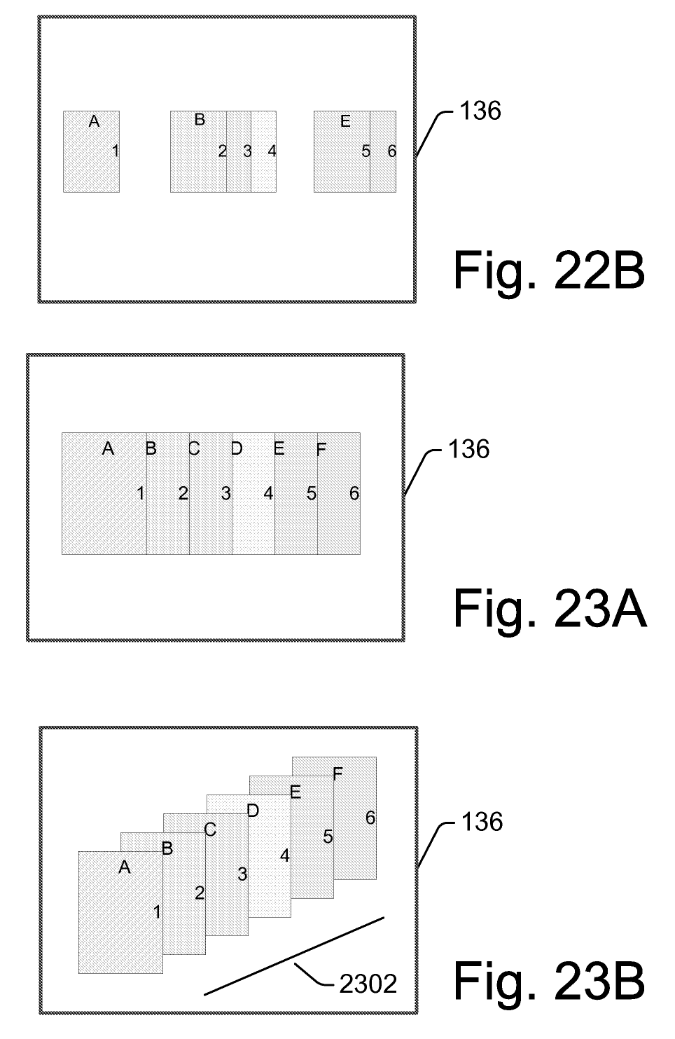

At operation 1304, an image pile may be divided from one pile to two different piles. For example, a user may wish to divide an image pile between images to be printed and not printed. An example of this operation is illustrated by FIGS. 22A and 22B, wherein an image pile in FIG. 22A is divided into three image piles, seen in FIG. 22B.

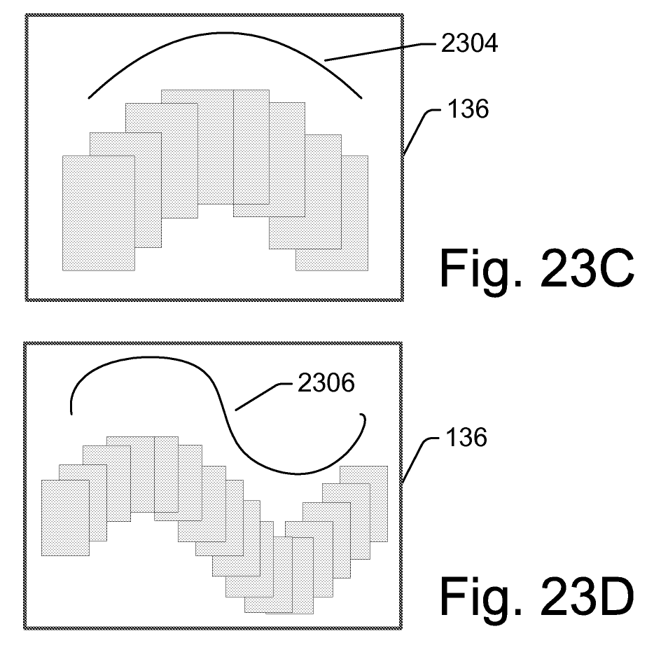

At operation 1306, an alignment of an image pile may be altered. Referring to FIGS. 23A through D, the horizontally aligned image pile of FIG. 23A can be altered, and to thereby display as seen in FIGS. 23B through D. For example, in FIG. 23B, a user's input using a mouse or touch screen, along line 2302 may result in display of the image pile as seen in FIG. 23B. Performing the change align pattern of FIG. 23B—which extends the image pile diagonally within a viewing area—is useful as a prelude to an in-depth rotate to efficiently use the screen area for the image pile display. Similarly, user input according to the curves 2304 and 2306 of FIGS. 23C and 23D may result in the curved image pile displays seen in those figures.

At operation 1308, a slide show of images of the image pile may be presented.

To support different manipulations of an image cube, image plane, image pile, individual image or other element, the functions of input devices (e.g., a mouse, touch screen, or 3D input device) may be enhanced, refined or redefined. For example, mouse operations can optionally be altered to allow pushing of the right and left buttons simultaneously, optionally combined with mouse movement to the left or right. Such mouse operations can be associated with functions, such as shrinking or extending a selected image pile. As a further example, pushing left and right mouse buttons simultaneously, optionally combined with mouse movement up or down may be used to in-depth rotate thumbnails in a selected image pile. If a touch screen is available, touching the screen with two or more fingers and moving left or right might shrink or extend a selected image pile. Touching the screen using two or more fingers and moving up or down might in-depth rotate thumbnails in a selected pile. Thus, for the functions described herein can be invoked by operation of a mouse, touch screen or other user interface device. Some enhancement or redefinition of the mouse or touch screen commands may be useful, to invoke the varied functionality described herein.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable media storing computer-executable instructions that, when executed, cause one or more processors to perform acts comprising:
displaying an image cube;
displaying an image plane, the image plane selected from the image cube; and
displaying an image pile, the image pile selected from the image plane.

2. One or more computer-readable media as recited in claim 1, wherein displaying the image cube comprises displaying the image cube according to a first axis, distance along which is associated with different body parts, a second axis, distance along which is associated with modality, and a third axis, distance along which is associated with time.

3. One or more computer-readable media as recited in claim 1, wherein displaying the image cube comprises display of user interface tools for:
translating along at least one axis of the image cube; and
scaling of at least one axis of the image cube.

4. One or more computer-readable media as recited in claim 1, wherein displaying the image cube comprises display of user interface tools for:
rotating the image cube;
zooming in and out with respect to the image cube;
making image planes of the image cube translucent; and
selecting an image plane from the image cube.

5. One or more computer-readable media as recited in claim 1, wherein displaying the image cube comprises display of user interface tools for:
translating along an axis of the image cube to obtain a desired range of dates along the translated axis;
scaling an axis of the image cube to change a number of image planes visible within a viewing region;
adjusting transparency of at least one image plane within the image cube, the adjusting resulting in appearance of image piles in other image planes;
realigning the image planes to adjust for complete transparency of one or more image planes; and
selecting an image plane from among image planes in the image cube.

6. One or more computer-readable media as recited in claim 1, wherein displaying the image cube comprises display of user interface tools for:
reversing an order of image planes within the image cube;
switching a cover sequence of image planes within the image cube;
shuffling the image planes to change an order of the image planes; and
emerging an image plane from among the image planes to position the emerged plane for viewing.

7. One or more computer-readable media as recited in claim 1, wherein displaying the image cube comprises display of user interface tools for:
selecting an image plane from the image cube; and
in-depth rotating the selected image plane to produce a plan view of the image plane.

8. One or more computer-readable media as recited in claim 1, wherein displaying an image pile comprises display of user interface tools for:
extending the image pile within a viewing area;
switching the image pile within the viewing area;
reversing the image pile within the viewing area;
in-plane rotating the image pile within the viewing area;
emerging an image from the image pile within the viewing area;
selecting the emerged image; and
displaying a high-resolution image associated with the selected image.

9. A method, comprising:
storing, in a memory communicatively coupled to a processor, computer-executable instructions for performing the method;
executing the instructions on the processor;
according to the instructions being executed:
displaying an image cube in a viewing area to appear as a plurality of image planes organized by three mutually perpendicular axes;
selecting an image plane;
translating along an axis of the selected image plane;
scaling an axis of the selected image plane;
selecting at least one image pile from the selected image plane;
performing image pile operations on the at least one image pile; and
viewing an image associated with a thumbnail image from among the at least one image pile.

10. The method recited in claim 9, wherein displaying the image cube comprises:
displaying a plurality of image planes, each image plane associated with a different human body part; and
displaying an image pile in an image plane from among the plurality of image planes, the displayed image pile located at a position within the image plane based on a modality of images in the image pile and a date on which the images were created.

11. The method recited in claim 9, wherein:
translating along at least one of the three axes groups image piles of a different date range within the image planes; and
scaling at least one of the three axes changes a number of image planes visible within a viewing region.

12. The method recited in claim 9, wherein selecting an image comprises:
highlighting an image plane; and
in-depth rotating the highlighted image plane to result in a orthographic view of the highlighted image plane.

13. The method recited in claim 9, wherein performing image pile operations comprises:
performing a shrink/extend function to adjust an overlay of thumbnails within an image pile;
emerging an image from the image pile;
selecting the emerged image; and
displaying a high-resolution image associated with the selected image.

14. The method recited in claim 9, wherein performing image pile operations comprises:
merge two piles of images into a merged image pile;
performing change align pattern to extend the merged image pile diagonally within a viewing area;
in-depth rotating the merged image pile;
emerging an image from the merged image pile;
selecting the emerged image; and
displaying a high-resolution image associated with the selected image.

15. A system comprising:
a memory communicatively coupled to a processor;
an image manager, defined on the memory and executed by the processor, the image manager comprising:
a data structure defining an image cube, the image cube in an exploded configuration comprising image planes organized about three mutually perpendicular axes, the axes comprising a first axis, distance along which is associated with different body parts of a medical patient, a second axis, distance along which is associated with modality, and a third axis, distance along which is associated with time, the data structure also defining a plurality of image piles located at a plurality of respective positions within the image cube;
an image cube manager to display the image cube and to allow selection of image planes;
an image plane manager to display a selected image plane and to allow selection of an image pile; and
an image pile manager to display a selected image pile and to manipulate the selected image pile within a viewing region.

16. The system as recited in claim 15, wherein the image cube manager responds to user interface tools for:
zooming the image cube in and out to display a desired amount of the image cube within the viewing region; and
rotating the image cube to position a desired portion of the image cube within the viewing region.

17. The system as recited in claim 15, wherein the image cube manager responds to user interface tools for:
performing an axis-scaling function to adjust a number of body parts displayed by one axis;
emerging an image plane from the image cube; and
selecting the emerged image plane.

18. The system as recited in claim 15, wherein the image plane manager responds to user interface tools for:
scaling an axis of the image plane to change a number of image date displayed by the selected image plane; and
translating the axis of the image plane to change image dates displayed.

19. The system as recited in claim 15, wherein the image pile manager responds to user interface tools for:
merging two piles of images into a merged image pile;
performing change align pattern to extend the merged image pile diagonally within a viewing area;
in-depth rotating the merged image pile;
selecting an image from the merged image pile; and
displaying an enlargement of the selected emerged image within the viewing area.

20. The system as recited in claim 15, wherein the image pile manager responds to user interface tools for:
performing a shrink/extend function to overlay images of the image pile within a viewing area;
switching the image pile within the viewing area;
reversing the image pile within the viewing area;
emerging an image from the image pile within the viewing area;
selecting the emerged image; and
displaying a high-resolution image associated with the selected emerged image.
